(19) United States
(12) Patent Application Publication
(10) Pub. No.: US 2021/0281052 A1
(43) Pub. Date: Sep. 9, 2021

(54) MOBILE GUARD STRUCTURE

(71) Applicant: Wagner-Smith Equipment Co., Dayton, OH (US)

(72) Inventors: Steven Ray Vaughn, Mansfield, TX (US); Joe Villanueva, Rio Vista, TX (US)

(21) Appl. No.: 17/190,055

(22) Filed: Mar. 2, 2021

Related U.S. Application Data
(60) Provisional application No. 62/986,428, filed on Mar. 6, 2020.

(51) Int. Cl. H02G 1/02

(52) U.S. Cl. CPC H02G 1/02

(57) ABSTRACT

A mobile line guard apparatus including a movable platform and an articulating support arm mounted to the movable platform. The support arm being upwardly extendable from a stowed position to a height above the movable platform. The support arm can include at least one arm segment and at least one arm actuator positioned between the platform and the arm segment to extend the support arm upwardly from the stowed position. An articulating guard structure can be pivotably coupled to a distal end portion of the support arm. The guard structure can include a base portion, a horizontal beam rotatably coupled to the base portion, a pair of guide rods, each extending at an angle from opposite ends of the horizontal beam, and a guard actuator positioned between the base portion and the distal end portion of the support arm to angle the guard structure with respect the support arm.

### CROSS-REFERENCE TO RELATED APPLICATION

This application claims the benefit of and priority to U.S. Provisional Patent Application No. 62/986,428, filed Mar. 6, 2020, the disclosure of which is incorporated herein by reference in its entirety.

### BACKGROUND

Guard structures are pieces of equipment designed to address “crossing structures” during the installation of overhead powerlines. Two industry standards, IEEE 524 Section 10.2.1 and IEC TR 61328 Section 6.2.2, provide that protective guard structures are necessary for preventing accidentally dropped lines from falling onto roadways, walkways, or intersecting pathways; however, they do not specify design criteria or features. Lines include, but are not limited to pilot (steel or synthetic), grounding, or conductor lines.

Previously known guard structures used to guard roadways, walkways, or intersecting pathways have presented a number of undesirable shortcomings. One such guard structure combines a conventional bucket truck with a guard attachment. However, several guard structures may be needed at a single site where lines are being installed or serviced. Bucket trucks are expensive pieces of equipment for which other purposes are better suited for their use. Moreover, guard structures are oftentimes left in position for extended periods of time. It is impractical to leave one or more bucket trucks at a site until the line work is complete. Bucket trucks are categorized as a work platform, which should not be left unattended. Bucket trucks have been damaged at the boom, due to low stringing lines, which requires costly repairs. Contractors using such equipment may also have liability concerns for dropped lines. The bucket truck and the boom attachment manufacturers do not assume any liability when an accident occurs. In such instances, the manufacturers state that their products were being used in an unintended manner. Another structure used in the industry includes one or more wooden goal post structures that are erected on the job site. However, such structures take significant, valuable time to erect. Post holes must be dug at the site. The goal posts are inserted into the holes, which then must be back-filled in a manner that safely secures the goal posts in position.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The mobile guard structure of the present technology protects people and equipment at crossings beneath lines that are being pulled/tensioned during stringing. In various embodiments, the mobile guard structure includes an articulating support arm that extends upwardly from a towable trailer. An articulating guard is coupled to a distal end portion of the support arm. Embodiments of the present technology provide a mobile guard structure that does not include a working platform.

Embodiments of the mobile guard structure lift the articulating guard to a position adjacent to the line being pulled or temporarily stationed. The mobile guard structure typically comes into contact with the line during an accidental drop, which is undesirable as related to safe pulling/stringing operations.

These and other aspects of the present systems and methods will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the mobile guard structure of the present technology in a retracted position.

FIG. 2 depicts a rear elevation view of the mobile guard structure of FIG. 1 in a retracted position.

FIG. 3 depicts a side elevation view of the mobile guard structure of FIG. 1 in a retracted position.

FIG. 4 depicts a front elevation view of the mobile guard structure of FIG. 1 in a retracted position.

FIG. 5 depicts a perspective view of the mobile guard structure of FIG. 1 in an extended position.

FIG. 6 depicts a perspective view of the mobile guard structure of FIG. 1 in another extended position.

FIG. 7 depicts a side elevation view of another embodiment of the mobile guard structure of the present technology in a retracted position.

FIG. 8 depicts side elevation and front elevation views of the mobile guard structure of FIG. 7 in an extended position.

FIG. 9 depicts an isometric view of one embodiment of an articulating guard that can be used with the mobile guard structure of the present technology.

FIG. 10 depicts a front elevation view of the articulating guard of FIG. 9.

FIG. 11 depicts an isometric view of one embodiment of hydraulic controls that can be used with the mobile guard structure of the present technology.

FIG. 12 depicts a perspective view of still another embodiment of the mobile guard structure of the present technology in an extended position.

FIGS. 13a and 13b depict a flow diagram of one method of positioning and erecting the mobile guard structure of the present technology for use.

FIG. 14 depicts a flow diagram of one method of retracting and placing the mobile guard structure of the present technology in a travel-ready condition.

FIG. 15 depicts a perspective view of another embodiment of the mobile guard structure of the present technology in a retracted position.

FIGS. 16a and 16b depict front and rear elevation views of the mobile guard structure of FIG. 15.

FIG. 17 depicts a perspective view of the mobile guard structure of FIG. 15 in an extended position.

FIG. 18 depicts a side elevation view of the mobile guard structure of FIG. 15 in a retracted position.

FIG. 19 depicts an isometric view of another embodiment of an articulating guard that can be used with the mobile guard structure of the present technology.

FIG. 20 depicts an enlarged partial perspective view of the mobile guard structure of FIG. 15.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

What is needed is a new guard structure that can be quickly transported over a roadway to a job site. Such a structure should save contractors time and money. In particular, the guard structure should accomplish the support and safety goals at a fraction of the expense spent on bucket trucks and a fraction of the time required to erect wooden goal posts. The guard structure should also obviate the necessity to comply with OSHA and ANSI standards that regulate bucket booms that approach powerlines from below. The guard structure should also be capable of being left unattended as an unmanned, stationary device.

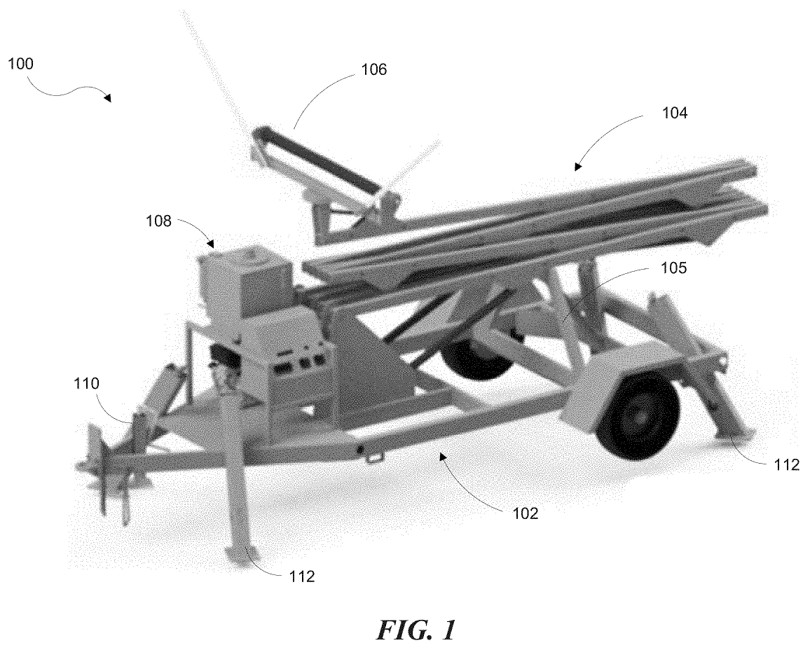

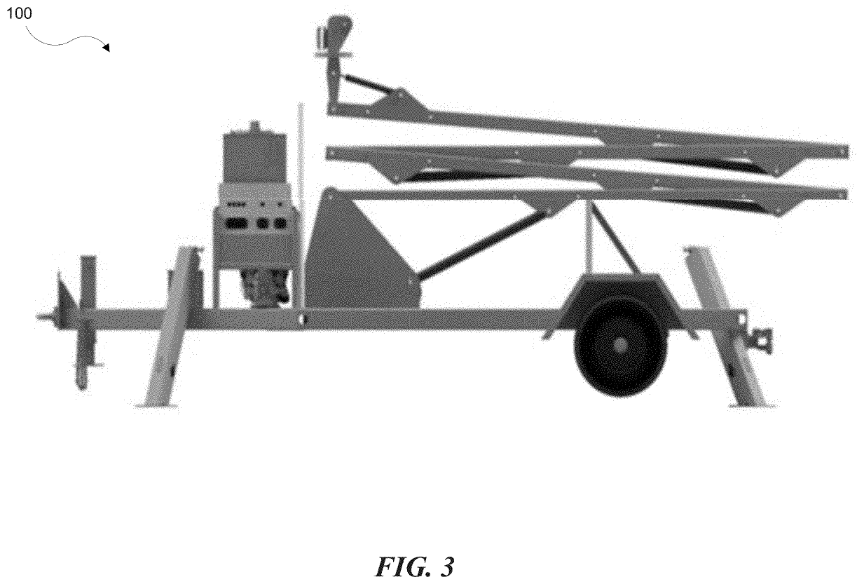

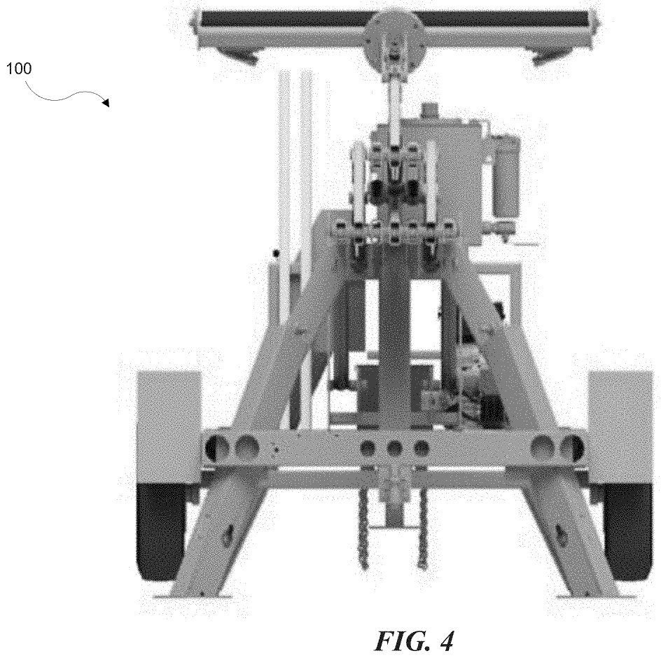

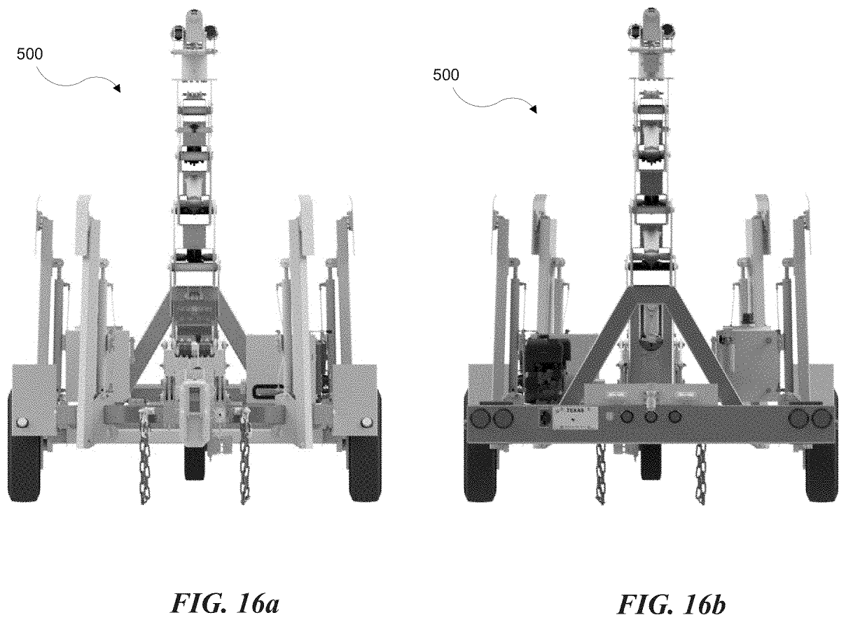

With reference to FIGS. 1-20 embodiments of the mobile guard structure and methods therefor of the present technology are presented. After reviewing the present application it will be clear that the mobile guard structures of the present technology involve minimal setup labor and time and may be left unattended. Most embodiments of the mobile guard structure may simply be set it up and left at the worksite because they do not have to be attended. Such embodiments are unmanned structures, which present less risk to personnel. The present technology achieves the needs of protecting people and equipment at crossings, beneath lines that are being pulled/tensioned during stringing, with less cost than previously known options.

In various embodiments, the mobile guard structure includes an articulating support arm that extends upwardly from a towable trailer. An articulating guard is coupled to a distal end portion of the support arm. Embodiments of the present technology provide a mobile guard structure that does not include a working platform, which typically requires additional restrictions and safeguards that are unnecessary for line pulling applications.

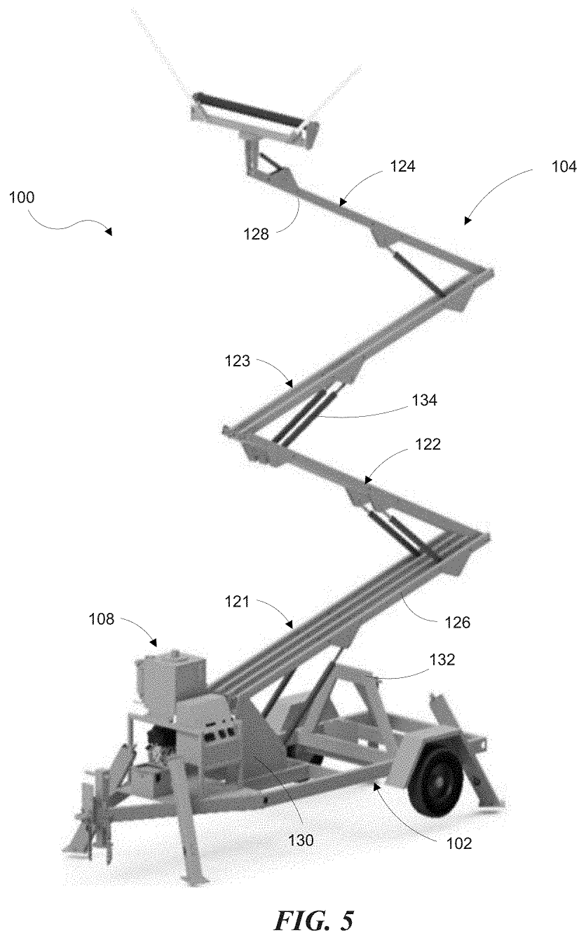

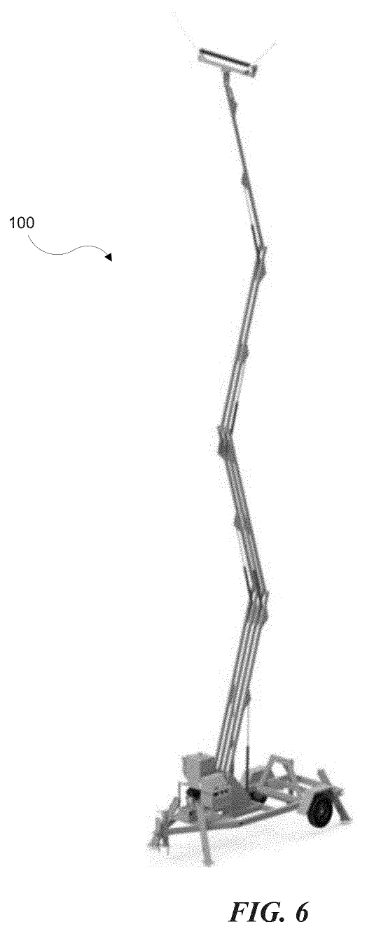

FIGS. 1-4 depict a mobile guard structure (MGS), also referred to herein as a mobile line guard apparatus 100. In some embodiments, the mobile guard apparatus 100 can include a movable platform 102 and an articulating support arm 104 mounted to the movable platform 102. The support arm 104 is upwardly extendable from a stowed position, as shown in e.g., FIGS. 1-4, to a selected height above the movable platform, as shown in e.g., FIGS. 5 and 6. In some embodiments, an articulating guard structure 106 is pivotably coupled to a distal end portion of the support arm 104.

In some embodiments, the movable platform 102 can comprise a towable trailer. The trailer can include a dual purpose jack and drive mechanism 110. This can be used to raise and lower the trailer tongue mechanically by crank. The wheel drive is powered via a hydraulic drive and is controlled by the hydraulic control/power unit 108. Once the trailer has been disconnected from the towing vehicle, the wheel drive 110 can relocate the MGS short distances to position the guard directly below the desired location. The mobile platform 102 can also include outrigger jacks 112 positioned on all four corners to stabilize the MGS when the support arm is 104 is extended. In some embodiments, the jacks 112 have telescoping tubes with a hydraulic cylinder inside to lift and level the trailer. The jacks can also be controlled by the hydraulic control/power unit 108. In some embodiments, the movable platform 102 can include an arm support frame 105 including a steel tubular A-frame that rises from the top of the trailer to provide support for the support arm 104 during transport.

With reference to FIG. 5, the support arm 104 can be mounted to the movable platform 102 via a base structure 130. In some embodiments, the support arm 104 can include a plurality of arm segments. For example, in the depicted embodiment, the support arm includes first 121, second 122, third 123, and fourth 124 arm segments. Selected ones of the arm segments each include a plurality of spaced apart segment members. For example, first arm segment 121 includes four parallel spaced apart segment members 126. Similarly, second and third arm segments 122 and 123 each include three and two segment members 126, respectively. The fourth arm segment includes a single segment member 128. The first 121, second 122, and third 123 arm segments each include a pair of corresponding actuators 134 and the fourth segment 124 includes one actuator 134. In some embodiments, the actuators 134 can be hydraulic cylinders controlled and powered by the hydraulic control/power unit 108.

As shown in the figures, the segment members of adjacent arms are interleaved with each other and pivotably coupled using suitable hardware, such as stress proof pins. The interleaved support arm joints provide a rigid coupling between segments and allow the segments to at least partially nest within each other. Furthermore, the spaced apart segment members facilitate mounting the actuators 134 to allow the segments to nest. The segment members 126/128 can each comprise a tube weldment including for example, steel tubing, machined pin bosses, and cylinder mounting plates.

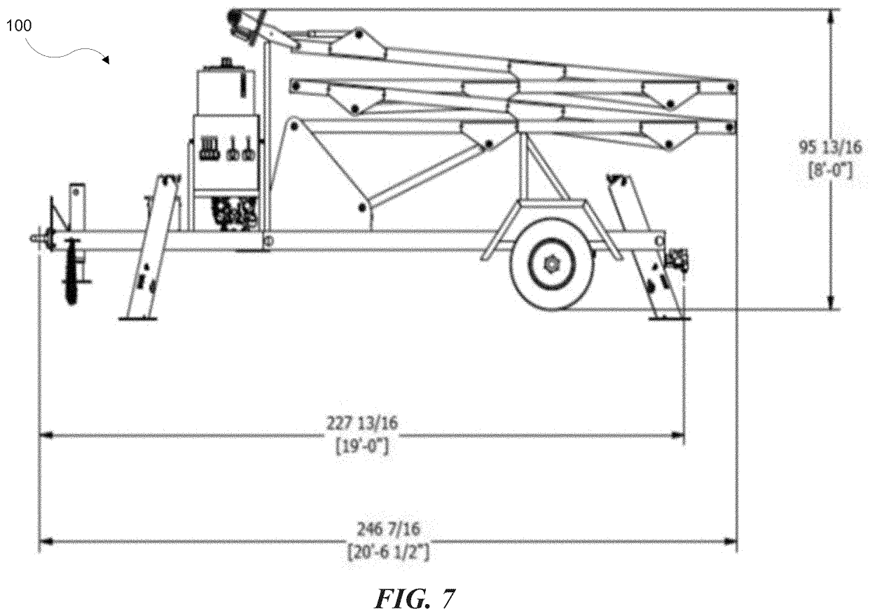

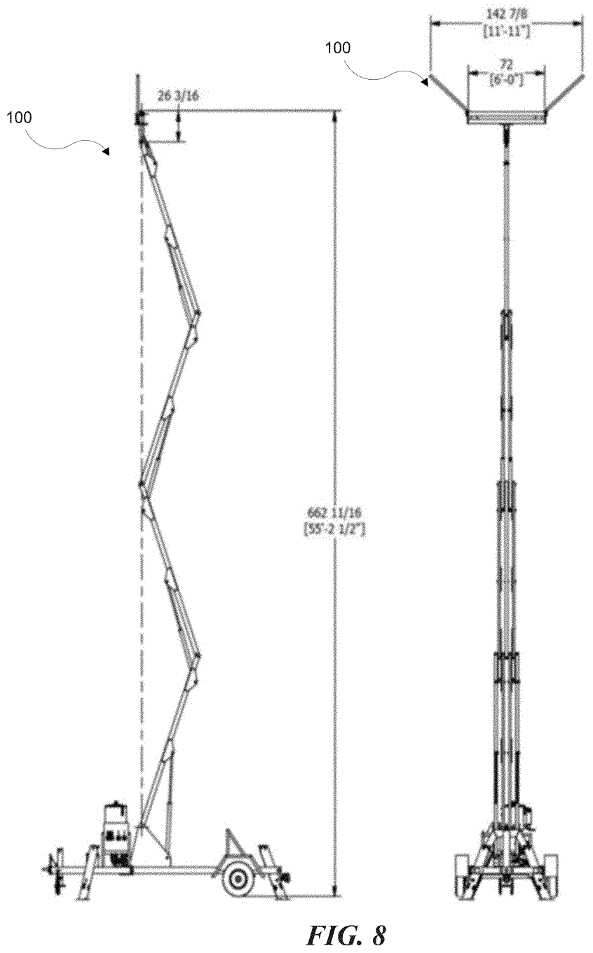

FIGS. 7 and 8 provide representative dimensions for the mobile line guard apparatus 100, according to embodiments of the disclosed technology. The representative dimensions are intended only as examples and are not to be construed as limiting. Other suitable dimensions can be used.

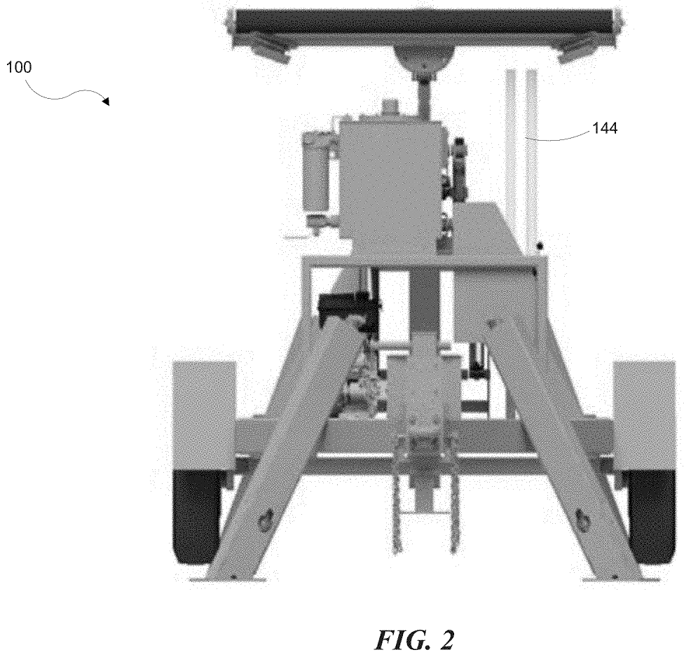

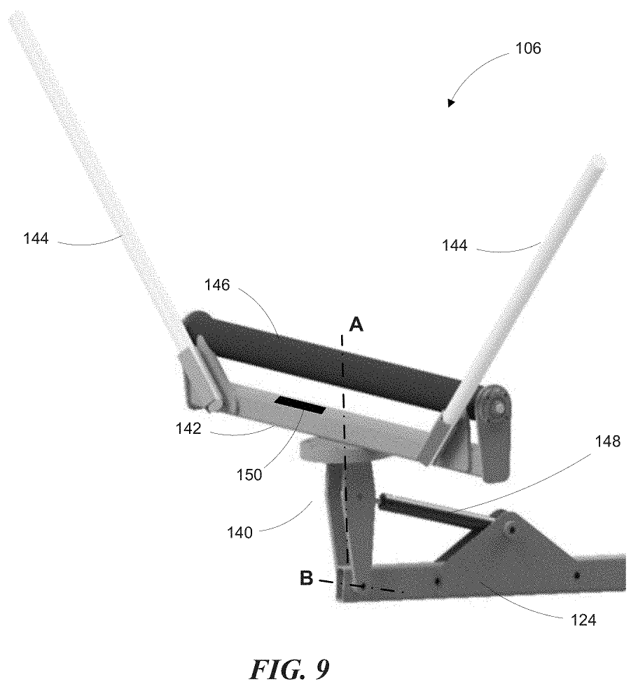

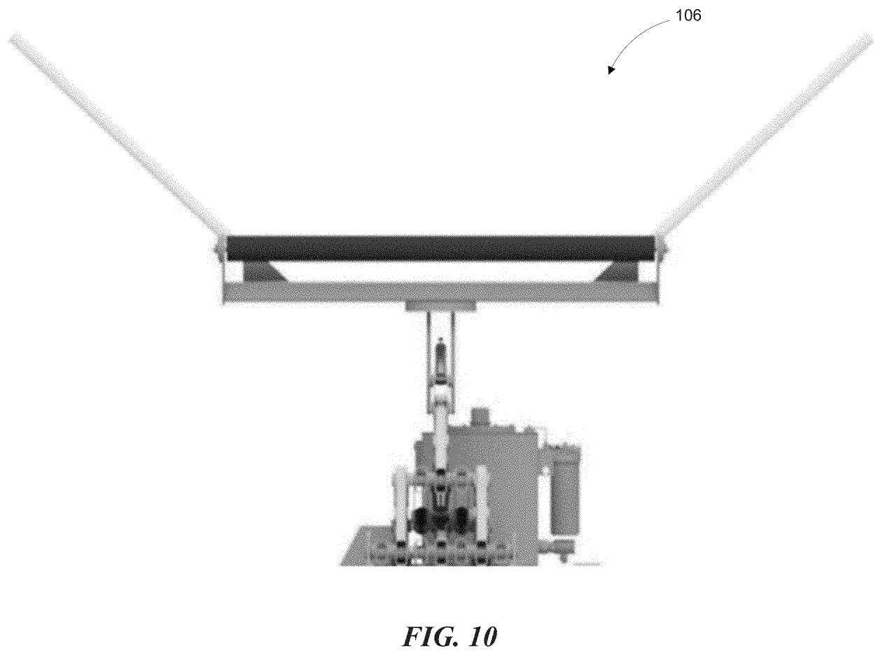

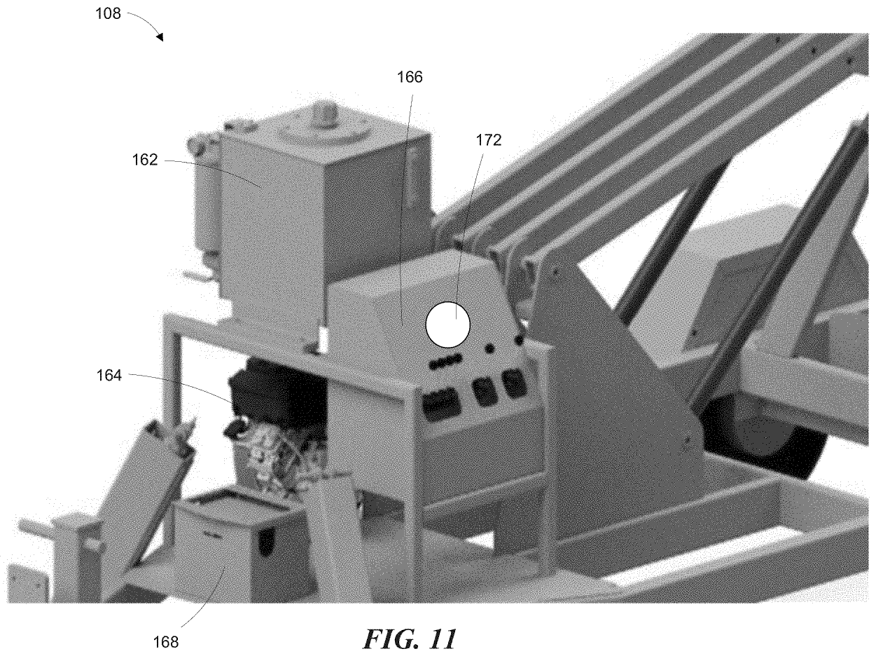

Referring to FIGS. 9 and 10, the guard structure 106 can include a base portion 140, a horizontal beam 142 rotatably coupled to the base portion 140, and a pair of removable guide rods 144. In some embodiments, a roller 146 can be rotatably mounted adjacent the horizontal beam 142. The horizontal beam 142 is rotatable about axis A to position the guard to be orthogonal to the power lines of interest. The selected rotational position of the horizontal beam can be retained with quick release pins (not shown), for example. Each guide rod 144 extends at an angle from opposite ends of the horizontal beam 142. A guard actuator 148 can be positioned between the base portion 140 and a distal end portion of the support arm (i.e., fourth arm segment 124) to angle the guard structure 106 about axis B with respect the support arm in order to position the guide rods 144 in a generally vertical orientation, as shown. In some embodiments, the guard structure 106 can include an electro-magnetic field (EMF) sensor 150 mounted to the guard structure and electrically coupled to a warning device. The EMF sensor 150 can be used as a proximity sensor such that if the guard structure is positioned too close to a live line the warning device 172 (FIG. 11) is activated. In some embodiments, the guide rods 144 and roller 146 comprise dielectric or insulating material. For example, the guide rods 144 can comprise ultra-high molecular weight polyethylene (UHMW) and the roller 146 can comprise rubber. In some embodiments, the guide rods 144 can be removed and stowed on the movable platform 102 for transport (see FIGS. 2-4). In some embodiments, the guide rods can be equipped with suitable actuators (not shown) to fold the rods between stowed and extended positions.

As shown in FIG. 11, the hydraulic control/power unit 108 is carried on the movable platform 102 and can include a hydraulic fluid tank 162, an engine/hydraulic pump 164, and a control box 166. The control box 166 can comprise suitable electrical and hydraulic controls to operate the actuators 134/148 and a warning device 172. In some embodiments, the warning device 172 is a siren. Power for the apparatus can be derived from the engine 164 and/or a battery pack 168.

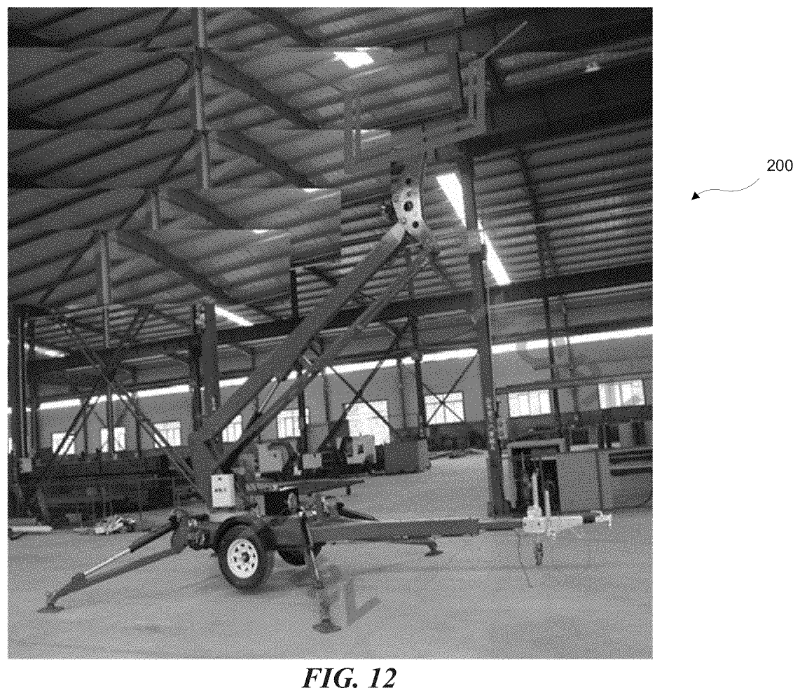

FIG. 12 depicts a mobile guard structure 200 according to another embodiment of the disclosed technology. Mobile guard structure 200 includes a mobile platform in the form of a trailer with a four-bar linkage style arm supporting a guard structure.

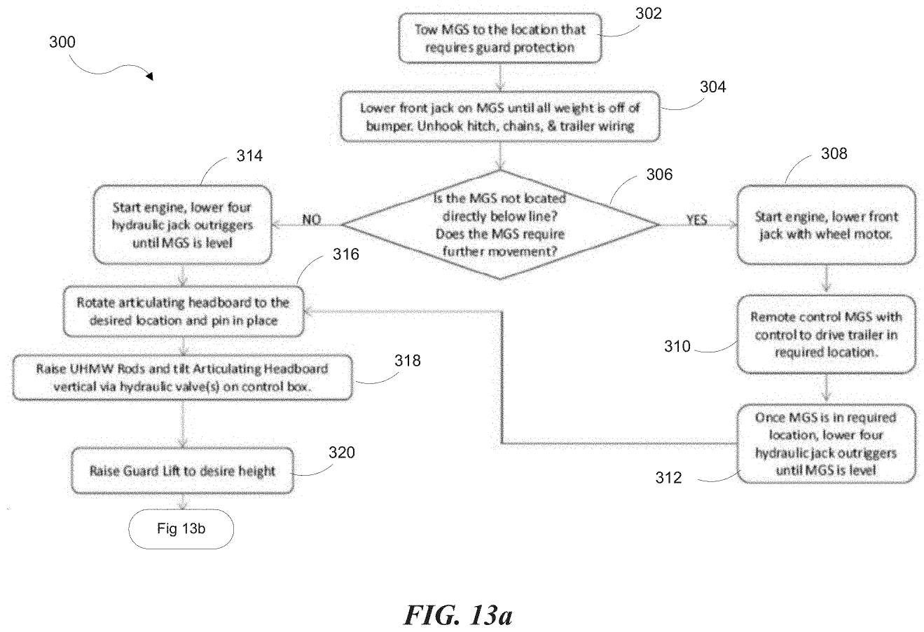

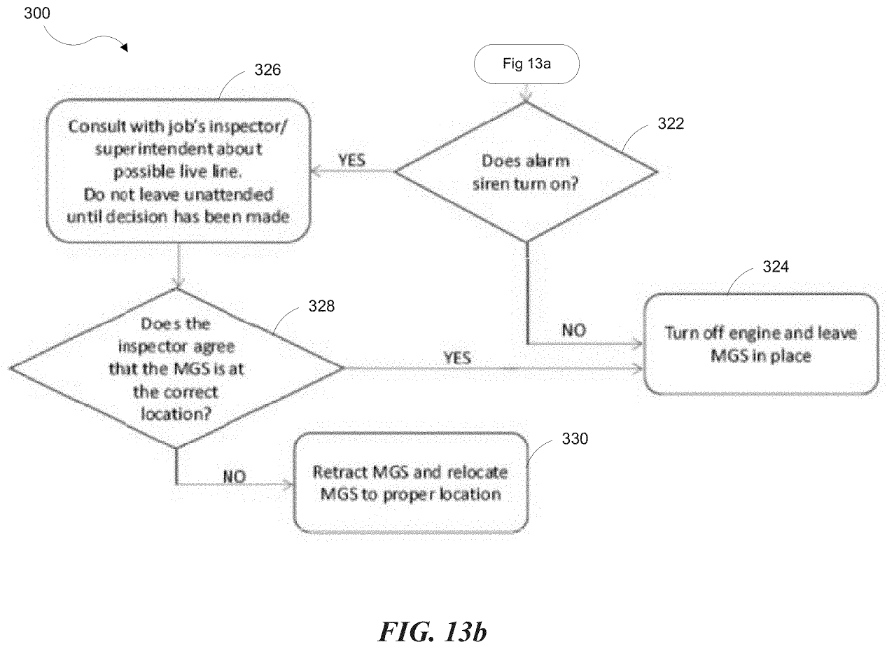

With reference to FIGS. 13a and 13b a method 300 for preventing power lines from falling on surfaces located below the power lines is presented. At step 302, an articulating support arm (e.g., MGS) is positioned below one or more power lines, wherein the support arm carries a guard structure configured to support the one or more power lines in the event of a drop. This can be accomplished by towing the MGS to the location that requires guard protection. At step 304, the jack/drive mechanism can be lowered and the trailer disconnected from the tow vehicle. At step 306, it is determined whether the MGS requires further positioning. If the MGS needs further positioning, the engine is started at step 308 to provide power to the drive mechanism and the MGS is moved into position using the drive mechanism at step 310. Once in position the outriggers are lowered at step 312. Returning to step 306, if the MGS does not need further positioning, the outriggers are deployed at step 314. In either case, once the outriggers are deployed at step 312 or 314, the guard structure (also referred to as a headboard) is rotated relative to the articulating support arm to be oriented generally orthogonal to the power lines at step 316. At step 318 the guard structure is pivoted relative to a distal end portion of the support arm to a substantially vertically oriented position (as shown in e.g., FIG. 5). At step 320, the articulating support arm is extended from the stowed position to a selected distance below the one or more power lines (i.e., a desired height). Moving to FIG. 13b, at step 322, it is observed whether the warning device (e.g., siren) indicates that the power lines are live. If not, the engine is turned off and the MGS is left in place at step 324. If the warning device indicates the presence of live lines, the situation is evaluated at step 326. If it is determined that the MGS is in the correct location, the engine is turned off and left in place at step 324. Otherwise, the support arm is retracted and the MGS is relocated to the proper location at step 330.

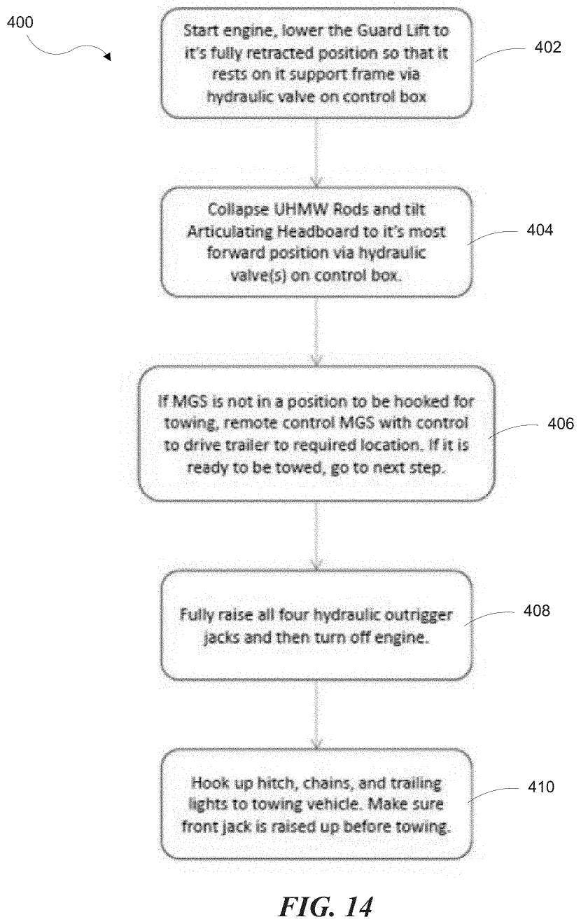

FIG. 14 depicts a method 400 for retracting and placing the mobile guard structure of the present technology in a travel-ready condition. At step 402, the engine is started and the support arm is lowered to its fully retracted (e.g., stowed) position such that it rests on the arm support frame. At step 404, the guard structure is pivoted to its most forward position. At step 406, the MGS can be positioned for towing with the drive mechanism. At step 408, the outriggers are raised and the engine turned off. At step 410, the MGS is hitched to the tow vehicle and the jack is raised.

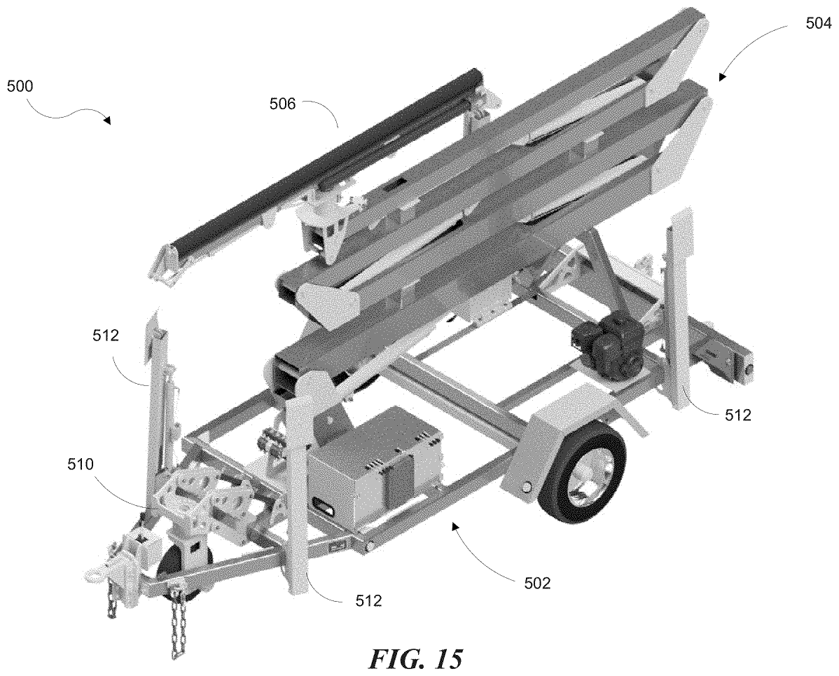

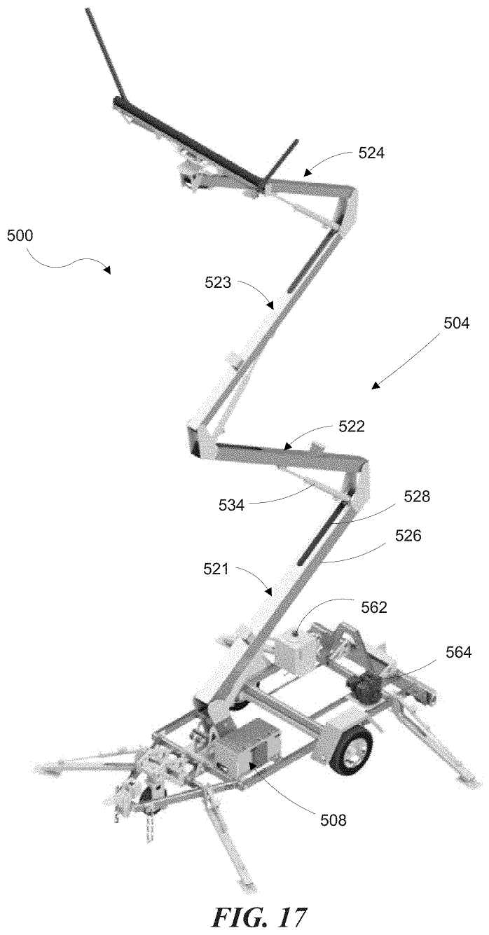

FIGS. 15-20 depict a mobile line guard apparatus 500 according to some embodiments of the disclosed technology. In some embodiments, the mobile guard apparatus 500 can include a movable platform 502 (e.g., trailer) and an articulating support arm 504 mounted to the movable platform 502. The support arm 504 is upwardly extendable from a stowed position, as shown in e.g., FIG. 15, to a selected height above the movable platform, as shown in e.g., FIG. 17. In some embodiments, an articulating guard structure 506 is pivotably coupled to a distal end portion of the support arm 504.

In some embodiments, the trailer can include a dual purpose jack and drive mechanism 510. This can be used to raise and lower the trailer tongue and relocate the MGS short distances to position the guard directly below the desired location. The mobile platform 502 can also include folding outriggers jacks 512 positioned on all four corners to stabilize the MGS when the support arm is 504 is extended. In some embodiments, the outriggers 512 can include a hydraulic cylinder to fold the arms down and level the trailer.

With reference to FIG. 17, in some embodiments, the support arm 504 can include a plurality of arm segments. For example, in the depicted embodiment, the support arm includes first 521, second 522, third 523, and fourth 524 arm segments. The arm segments can each include a corresponding actuator 534. In some embodiments, the actuators 534 can be hydraulic cylinders controlled and powered via a control unit 508. The arm segments can each comprise a tubular member. In some embodiments, the arm segments can include a slot extending along a portion of the tubular member to provide clearance for the corresponding cylinder. For example, first arm segment 521 can include a tubular member 526 with a slot 528 to provide clearance for actuator 534 when the support arm is in the stowed position. The mobile line guard apparatus 500 can include a hydraulic fluid tank 562 and an engine/hydraulic pump 564 to provide hydraulic power via the control unit 508.

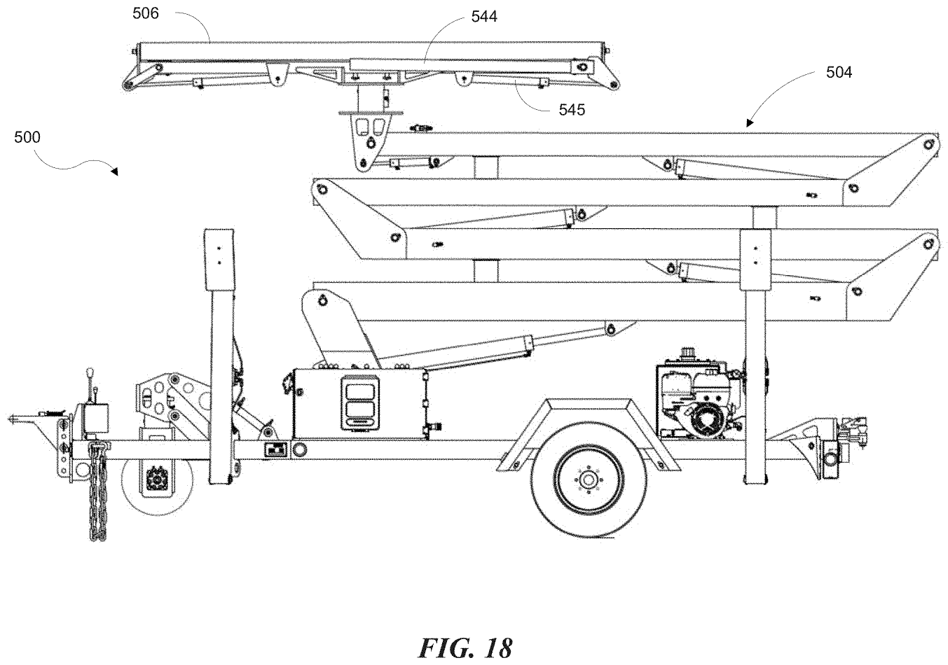

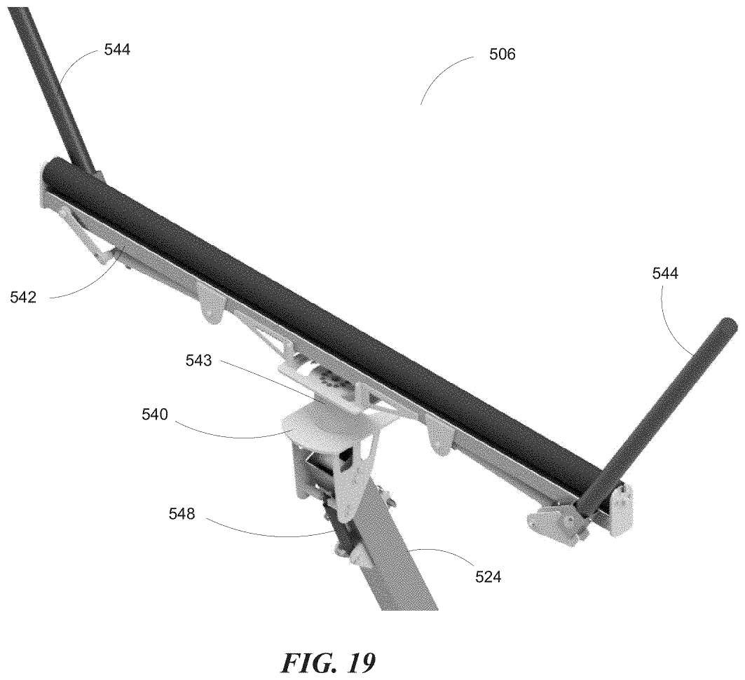

As shown in FIG. 18, the guard structure 506 can include a pair of articulating guide rods 544, each disposed on opposite ends of the structure. The guide rods 544 are also disposed on opposite sides of the structure such that they do not interfere with each other when in the folded position as shown. Each guide rode 544 is coupled to a corresponding actuator (e.g., hydraulic cylinder) 545 which is operative to move the guide rods between the folded position and an extended position, such as shown in FIG. 19.

Referring to FIG. 19, the guard structure 506 can include a base portion 540, a horizontal beam 542 rotatably coupled to the base portion 540 via rotary actuator 543. In some embodiments, a roller 546 can be rotatably mounted adjacent the horizontal beam 542. With rotary actuator 543, the horizontal beam 542 is rotatable (approximately 180 degrees) to position the guard to be orthogonal to the power lines of interest. When in the extended position, as shown, each guide rod 544 extends at an angle from opposite ends of the horizontal beam 542. A guard actuator 548 can be positioned between the base portion 540 and a distal end portion of the support arm (i.e., fourth arm segment 524) to angle the guard structure 506 (approximately 90 degrees) with respect to the support arm in order to position the guide rods 544 in a generally vertical orientation, as shown.

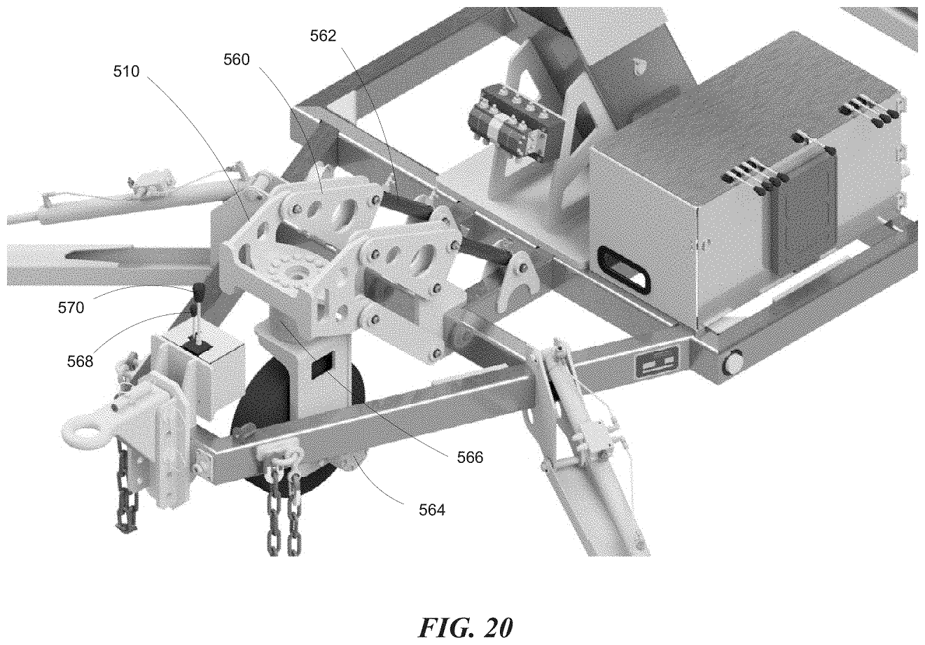

As shown in FIG. 20, the dual purpose jack and drive mechanism 510 can include a multi-link jack 560 operated by cylinders 562. In some embodiments, the up and down movement of the jack 560 can be controlled by a control lever 568. The drive mechanism can comprise a hydraulic drive motor 564 and a steering actuator 566. In some embodiments, the drive and steering functions can be controlled with a joy stick lever 570.

Some embodiments of the present technology can employ one or more of the following attributes in various combinations:
Maximum height of 55 feet from ground to horizontal roller after outriggers are lowered;
Four hydraulic cylinder outriggers that fold within the trailer frame;
At maximum height, withstand maximum 90 mph wind speed in all directions;
At maximum height, MGS can hold in place 1,000 lbs. (3:1 sf) for 24 hours, with no creep. If hydraulics cannot be contained, then a secondary fixed retainer may be employed.
Dielectric unit while in operation (Grounded Unit);
Outriggers can fold within the frame and level the mobile guard structure within 1% grade (OSHA 1926.1431);
Dual power hydraulically from engine/battery powered or quick disconnects via line truck;
Solar panel for battery recharge;
Elevation only boom, no rotation;
1,000 lb capacity;
3% grade achievable;
Powered by engine as well as quick disconnects;
One axle trailer with leaf springs (electric brakes);
Proximity sensor(s);
Rotatable “Bull horn” structure;
Manufactured using laser tube cutting;
trailer features to include one or more of wheel chocks & holders, 7-way plug, oil hub axles, fenders, area for toolbox on tongue, tie downs, etc.;
Lifting eyes on trailer frame;
Outrigger pad storage;
Onboard 2 axis level;
3″ lunette eye (vertical adjustable) & crank front jack;
Briggs & Stratton engine or battery powered using batteries as ballast;
Articulating guard, telescoping width protecting conductor from steel frame using UHMW. Bull horn structure to articulate.

Some embodiments of the present technology can employ one or more of the following components in various combinations:
Engine: Briggs & Stratton 25T2 Series 2100;
Pump Drive: None (direct coupling);
Hydraulic Pump: Sauer Danfoss Group 2 Gear Pump Model: SNP2/14-D-SC06;
3″ Pintle: Brinell BHN 255-285;
Pintle Hitch: DRA WBAR COMBINATION BALLEYE COUPLER McMaster Carr PN 2288T300;
Battery: BATTERY 12 VOLT, GROUP 34,540 CCA;
Overcenter Valves: Integrated Hydraulics 10EE34-F6T-35S5;
Solar Panel: SOLAR PANEL, 36 CELL 17.1 VDC 0.29A, GRAINGER PN 26KH34;
Bearings: BEARING, FLANGE 01.0″ BORE W/PILOT, DODGE #126167;
Vulcanized rubber coated roller: MC 3.5″ FF 72″ (3 SCH 40 PIPE 0.216 WALL)—A-1.5×77 LONG (1018) SHAFT TURNED DOWN TO 1.480 dia.±0.010×2 LONG EACH END WITH 0.250 60 DURO SBR VULCANIZED LAGGING GROUND FLAT TO 4 FINAL O.D.—ALL MILD STEEL CONSTRUCTION;
Hydraulic Cylinder: HYD. CYLINDER 2 ½×40 STROKE (48 RET) BAILEY 207422 SAE

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A mobile line guard apparatus, comprising:
a movable platform;
an articulating support arm mounted to the movable platform and upwardly extendable from a stowed position to a selected height above the movable platform, the support arm including:
at least one arm segment; and
at least one arm actuator positioned between the platform and the at least one arm segment to extend the support arm upwardly from the stowed position; and
an articulating guard structure pivotably coupled to a distal end portion of the support arm, the guard structure including:
a base portion;
a horizontal beam rotatably coupled to the base portion;
a pair of guide rods, each extending at an angle from opposite ends of the horizontal beam; and
a guard actuator positioned between the base portion and the distal end portion of the support arm to angle the guard structure with respect the support arm.

2. The apparatus of claim 1, wherein the movable platform comprises a towable trailer.

3. The apparatus of claim 2, further comprising a plurality of hydraulic outriggers coupled to the towable trailer.

4. The apparatus of claim 1, wherein the support arm comprises first, second, third, and fourth pivotably coupled arm segments.

5. The apparatus of claim 4, wherein the first, second, third, and fourth arm segments each include each include a tubular member.

6. The apparatus of claim 5, wherein the first, second, third, and fourth arm segments each include an actuator.

7. The apparatus of claim 1, further comprising an electro-magnetic field sensor mounted to the guard structure and electrically coupled to a warning device.

8. The apparatus of claim 1, wherein the at least one arm actuator comprises at least one hydraulic cylinder and further comprising a hydraulic pump carried by the moveable platform and coupled to the hydraulic cylinder.

9. A mobile line guard apparatus, comprising:
a movable platform;
an articulating support arm mounted to the movable platform and upwardly extendable from a stowed position to a selected height above the movable platform, the support arm including:
a plurality of arm segments, selected ones of which include a tubular member; and
at least one actuator coupled to each of the plurality of arm segments to extend the support arm upwardly from the stowed position; and
an articulating guard structure pivotably coupled to a distal end portion of the support arm, the guard structure including:
a base portion;
a horizontal beam rotatably coupled to the base portion;
a pair of pivoting guide rods, disposed on opposite ends of the horizontal beam; and
a guard actuator positioned between the base portion and the distal end portion of the support arm to angle the guard structure with respect the support arm.

10. The apparatus of claim 9, wherein the movable platform comprises a towable trailer.

11. The apparatus of claim 10, further comprising a plurality of hydraulic outriggers coupled to the towable trailer.

12. The apparatus of claim 9, wherein the support arm comprises first, second, third, and fourth pivotably coupled arm segments.

13. The apparatus of claim 12, wherein the first, second, third, and fourth arm segments each include a corresponding actuator.

14. The apparatus of claim 9, wherein the actuators comprise hydraulic cylinders and further comprising a hydraulic pump carried by the moveable platform and coupled to the hydraulic cylinders.

15. The apparatus of claim 9, further comprising an electro-magnetic field sensor mounted to the guard structure and electrically coupled to a warning device.

16. The apparatus of claim 9, further comprising a roller rotatably mounted adjacent the horizontal beam.

17. The apparatus of claim 16, wherein the guide rods and roller are comprised of dielectric materials.

18. A method for preventing power lines from falling on surfaces located below the power lines, the method comprising:
positioning an articulating support arm below one or more power lines, wherein the support arm carries a guard structure configured to support the one or more power lines;
rotating the guard structure relative to the articulating support arm to be oriented generally orthogonal to the one or more power lines;
upwardly extending the articulating support arm from a stowed position to a selected distance below the one or more power lines; and
pivoting the guard structure relative to a distal end portion of the support arm to a substantially vertically oriented position.

19. The method of claim 18, wherein the articulating support arm is mounted to a movable platform and further comprising stabilizing the movable platform.

20. The method of claim 19, wherein stabilizing the movable platform comprises extending a plurality of hydraulic outriggers coupled to the moveable platform.
